(19) United States
(12) Patent Application Publication
(10) Pub. No.: US 2024/0307760 A1
(43) Pub. Date: Sep. 19, 2024

(54) Hardware-Initiated Overlay Actions for a User-Input Element Such as a Software Service Button

(71) Applicant: Backbone Labs, Inc., Vancouver, WA (US)

(72) Inventors: Timothy Aldridge, Seattle, WA (US); Shawn O'Connor, Portland, OR (US); Joshua Donlan, Oviedo, FL (US)

(73) Assignee: Backbone Labs, Inc., Vancouver, WA (US)

(21) Appl. No.: 18/242,672

(22) Filed: Sep. 6, 2023

Related U.S. Application Data
(60) Provisional application No. 63/452,551, filed on Mar. 16, 2023.

(51) Int. Cl. A63F 13/22; A63F 13/42; A63F 13/533; A63F 13/77; A63F 13/92

(52) U.S. Cl. CPC A63F 13/22; A63F 13/42; A63F 13/533; A63F 13/77; A63F 13/92

(57) ABSTRACT

Embodiments disclosed herein are directed to a controller with a user-input element, such as a software service button, that can be programmed to accept various sequenced hardware-initiated input events (e.g., double press) that allow for other actions to overlay on top of default actions of a software service button. This can be accomplished, by way of example, through a custom accessory communication protocol that can receive the input events in the platform operating service application, even when the app is in the background to enable the various overlay actions. Thus, the user can use the overlay actions even when the platform operating service application is not in the foreground.

### CROSS-REFERENCE TO RELATED APPLICATION

This application claims the benefit of U.S. Provisional Patent Application No. 63/452,551, filed Mar. 16, 2023, which is hereby incorporated by reference.

### BACKGROUND

A controller can be used with a computing device to select and/or interact with content using user input devices on the controller. The content can be locally-stored on the computing device and/or streamed from a remote device. For example, the controller can be a game controller used to play a game that is native to the computing device and/or to play a game that is streamed from a remote server to a browser of the computing device.

### BRIEF DESCRIPTION OF THE DRAWINGS

FIG. 1 is a block diagram of a computing environment of an embodiment.

FIG. 2 is an illustration of a controller and a computing device of an embodiment.

FIG. 3 is a block diagram of a computing environment of an embodiment.

FIG. 4 is a screenshot of an embodiment presented after a user double taps a software service button.

FIG. 5 is a screenshot of an embodiment presented when a dependency of an overlay action needs to be resolved.

FIG. 6 is a screenshot of an embodiment presented after a dependency of an overlay action is successfully resolved.

FIGS. 7A, 7B, and 7C are flow charts of an input action of a software service button of an embodiment.

FIG. 8 is a block diagram of an embodiment for updating a software service button.

FIG. 9 is a block diagram of an embodiment for updating a software service button.

### DETAILED DESCRIPTION

### Introduction

The following embodiments generally relate to hardware-initiated overlay actions for a user-input element such as a software service button. Before turning to a description of example implementations, the following section provides an overview of an exemplary computing environment. It should be understood that these are merely examples and other implementations can be used. Accordingly, none of the details presented herein should be read into the claims unless expressly recited therein.

### Overview of an Exemplary Computing Environment

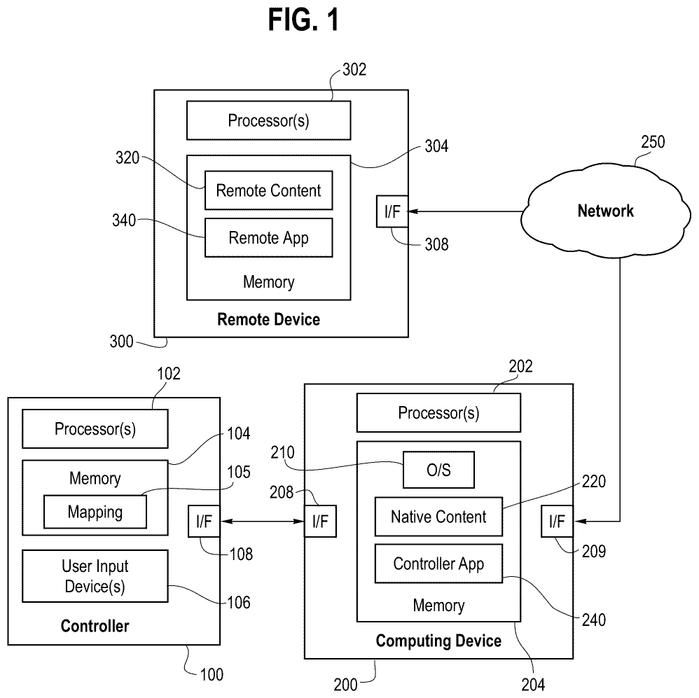

Turning now to the drawings, FIG. 1 is an illustration of a computing environment of an embodiment. As shown in FIG. 1, this environment comprises a user controller 100, a computing device 200, and a remote device 300. The user controller 100 and computing device 200 are in communication with each other via respective wired or wireless interfaces 108, 208. Likewise, the computing device 200 and the remote device 300 are in communication with each other via wired or wireless interfaces 209, 308. As used herein, “in communication with” can mean in direct communication with or in indirect communication with via one or more components, which may or may not be mentioned herein. For example, in the embodiment shown in FIG. 1, the computing device 200 and the remote device 300 are in communication with each other via a network 250 (e.g., the Internet, a local area network, a peer-to-peer wireless mesh, etc.). However, in other embodiments, the computing device 200 and the remote device 300 can communicate with each other in the absence of a network. Also, as used herein, the remote device 300 is “remote” in the sense that it is physically separate from the computing device 200 in some fashion. In many implementations, the physical distance is relatively great, such as when the remote device 300 is located in another town, state, or country. In other implementations, the physical distance may be relatively short, such as when the remote device 300 is in the same room or building as the computing device 200. Also, the term “remote device” can refer to a single remote device or multiple remote devices.

As shown in FIG. 1, in this embodiment, the controller 100 comprises one or more processors 102, a memory 104, and one or more user input devices 106. The user input devices 106 can take any suitable form, such as, but not limited to, a button, a joystick, a switch, a knob, a touch-sensitive screen/pad, a microphone for audio input (e.g., to capture a voice command or sound), a camera for video input (e.g., to capture a hand or facial gesture), etc. To be clear, as used herein a “user input device” refers to a control surface and not to the entire system or parent device on which user input devices are placed.

Generally speaking, the controller 100 can be used by a user in the selection and (passive or active) consumption of content (e.g., playing a game, watching a video, listing to audio, reading text, navigating a displayed user interface, etc.) presented using the computing device 200 in some fashion. The controller 100 may be referred to based on the content with which it is being used. For example, the controller 100 can be referred to as a game controller when it is being used to play a game. And if the controller 100 is being used to play a game on a mobile device, such as a phone or tablet (as opposed to a relatively-stationary game console), the controller 100 can be referred to as a mobile game controller. However, the same controller 100 may also be used to control the playback of non-game content, such as video or audio. Accordingly, a specific use should not be read into the term “controller” unless expressly stated.

The computing device 200 can also take any suitable form, such as, but not limited to, a mobile device (e.g., a phone, tablet, laptop, watch, eyewear, headset, etc.) or a relatively more-stationary device (e.g., a desktop computer, a set-top box, a gaming console, etc.). In the embodiment shown in FIG. 1, the computing device 200 comprises one or more processors 202 and a memory 204. In this particular embodiment, the memory 204 stores computer-readable program code for an operating system (O/S) 210 (e.g., iOS or Android), native content 220, and an application configured for use with the controller 100 (“controller app”) 240. This application 240 will sometimes be referred to herein as the client platform operating service or system. Exemplary functions of this application 240 will be described herein. Also, as used herein, “native content” refers to content that is at least partially stored in the computing device 200. For example, native content can be wholly stored on the computing device; or native content can be stored partially on the computing device 20 and partially on one or more remote devices 300 or some other device or set of devices.

The remote device 300 also comprises one or more processors 302 and memory units 304 storing remote content 320 and an application (“app”) 340 (which is sometimes referred to herein as the remote platform operating service or system) that can be used to communicate with the controller app 240 or another entity on the computing device 200.

It should be understood that more or fewer components than what are shown in FIG. 1 can be used. For example, the computing device 200 can have one or more user input device(s) (e.g., a touchscreen, buttons, switches, etc.), as well as a display (e.g., integrated with a touchscreen). Further, while the components in the controller 100, computing device 200, and remote device 300 are all shown in respective single boxes in FIG. 1, implying integration in respective single devices, it should be understood that the components can be located in multiple devices. For example, the processor 302 and memory 304 in the remote device 300 can be distributed over multiple devices, such as when the processor 302 is a server and the memory 304 is a remote storage unit. As used, the remote device 300 can also refer to multiple remote devices that are in communication with the computing device 200. Other variations for any of the devices 100, 200, 300 are possible.

Finally, the memory 104, 204, 304 in these various devices 100, 200, 300 can take any suitable form and will sometimes be referred to herein as a non-transitory computer-readable storage medium. The memory can store computer-readable program code having instructions that, when executed by one or more processors, cause the one or more processors to perform certain functions.

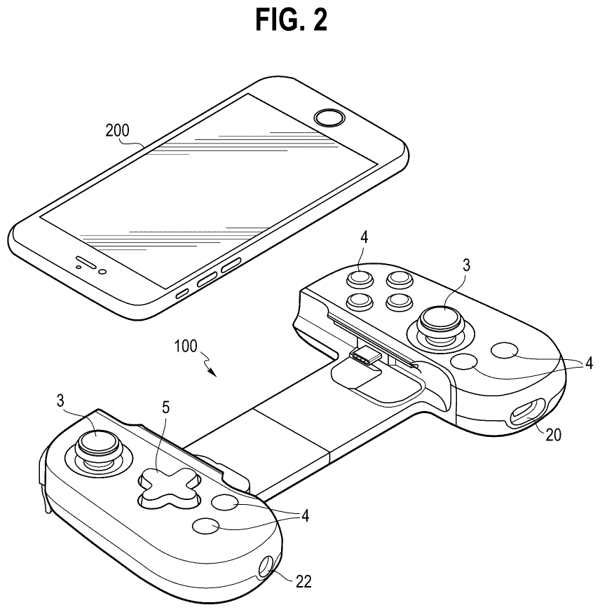

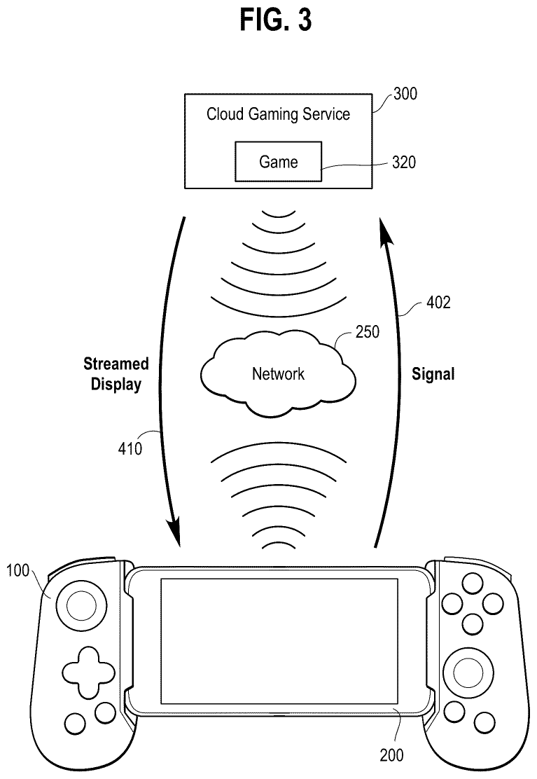

As mentioned above, the controller 100, computing device 200, and remote device 300 can take any suitable form. For purposes of describing one particular implementation of an embodiment, the controller 100 in this example takes the form of a handheld game controller, the computing device 200 takes the form of a mobile phone or tablet, and the remote device 300 takes the form of a cloud gaming system. This example is shown in FIGS. 2 and 3. Again, this is just one example, and other implementations can be used. Further, as mentioned above, a game is just one example of content that can be consumed, and the controller 100 can be used with other types of content (e.g., video, audio, text). So, the details presented herein should not be read into the claims unless expressly recited therein.

Turning first to FIG. 2, FIG. 2 shows an example handheld game controller 100 and mobile phone 200 of an embodiment. This game controller 100 has a number of user input devices, such as joysticks 3, buttons 4, and toggle switches 5. In this example, the game controller 100 takes the form of a retractable device, which, when in an extended position, is able to accept the mobile phone 200. A male communication plug on the controller 100 mates with a female communication port on the computing device 200 to place the controller 100 and computing device 200 in communication with one another. The controller 100 in this embodiment also has a pass-through charging port 20 that allows the computing device 200 to have its battery charged and a headphone jack 22. In other embodiments, the controller 100 can connect to the computing device 200 through other means such as pairing wirelessly to the phone 200. Again, this is just an example, and other types of controllers can be used, such as those that do not fit around a mobile device.

As shown in FIG. 3, in this embodiment, the controller 100 can be used to play a game that is locally stored on the computing device 200 (a “native game” 220) or a game 320 that is playable via a network 250 on a cloud gaming service 300. In this example embodiment, remote gameplay, based on input from the game controller 100, the computing device 200 sends signals 402 to the cloud gaming service 300 and receives display data 410 back. In one embodiment, a browser on the computing device 200 is used to send and receive the signals 402, 410 to stream the game 320 to the user. There can be multiple variants of remote game play. One embodiment includes a host device, such a game console, PC, or other computing device not actively being controlled that can be streamed to the active computing device, such as a smartphone, from a host device (e.g., game console or PC) that a user can access remotely via their smartphone) and Another embodiment includes a cloud gaming service (which can be streamed from a data center), such as Xbox Game Pass, Amazon Luna, or other service, that can be streamed to the active computing device.

In one embodiment, the controller app 240 can facilitate the selection of a game (or other content). For example, the controller app 240 can display a user interface (e.g., on a display of the computing device 200 or on another display). The controller app 240 can also receive user input from the controller 100 to navigate and engage with content, for example, browse for, select, and launch a game from a displayed list of games. In this example, once the game is launched, input from the game controller 100 can be provided directly to the game or indirectly to the game through the controller app 240. As will be discussed in more detail below, the controller app 240 can enhance the standard experience offered on a computing device by extending functionality and providing enhanced interface capabilities in addition to the inherent interface of the computing device itself. For example, in some embodiments, the controller app 240 assigns a function to one or more of the user input devices on the controller 100 based on the particular content being consumed.

Additional details and features, at least some of which can be used with these embodiments, can found in U.S. provisional patent application No. 63/422,797, filed Nov. 4, 2022, which is hereby incorporated by reference.

### Hardware-Initiated Overlay Actions for a Software Service Button

A game controller, such as a mobile game controller, has a limited amount of physical area to have buttons or other kinds of user-input elements. In addition to the finite number of buttons or input types (e.g., software service buttons that can be physically placed on a mobile game controller), there are a limited number of default actions for each button. If a mobile game controller needs to support additional actions, they either need to add additional buttons or have multiple overrides for buttons. For example, this can take the form of needing to add other platform or application-specific actions to a button.

On some game controllers (such as the Backbone controller), for instance, there is a button (e.g., a Backbone button) also known as the home button. The button opens up an application (e.g., the Backbone application) when the application is closed or in the background or switches the user back to the previous application when pressed if the application is in the foreground. It is desirable, however, to not change the operation of the button for one or more reasons, such as:

Brand confusion. For instance, users may become confused if multiple platform operating services are on the same button accessed through different gestures.

Reduced responsiveness. For instance, adding a double press gesture results in processing latency because the first press cannot be decided until enough time has elapsed that a double press sequence was ruled out.

Accidental invocation. Since users can already quickly tap the home button to switch apps back and forth, there is a significant chance of users producing an unintended action.

Embodiments disclosed herein are directed to a controller with a user-input element, such as a software service button (described below), that can be programmed to accept various sequenced hardware-initiated input events (e.g., double press) that allow for other actions to overlay on top of default actions of a software service button.

This can be accomplished, by way of example, through a custom accessory communication protocol that can receive the input events in the platform operating service application, even when the app is in the background to enable the various overlay actions. Thus, the user can use the overlay actions even when the platform operating service application is not in the foreground. For example: A user is playing a game and double taps a software service button to open a different application or platform service such as Playstation App that has been tied to the software service button through the overlay action.

Some terms, shown below, are used herein to describe various “game” or “gaming” embodiments. It is understood that other embodiments might be directed to non-gaming functions or tasks.

As used herein, a mobile game controller generally refers to a physical device, such as the physical hardware of Backbone One, and the game controller embedded software, which is configured to capture user inputs and interacts with a computing device to allow the user to play a video game or perform some other programmed task.

A platform operating service generally refers to game software app (one or more) and a cloud service (one or more). The game controller manufacturer can provide the game software app.

A computing device generally refers to an electronic device controlled by a CPU, such as a smartphone (e.g., an Apple iPhone or a smartphone that runs Android OS), a tablet (e.g., an Apple iPad or a tablet that runs Android OS), a laptop, desktop computer, game console, or some other type of mobile or non-mobile computing device that is controlled by a CPU and configured to run software programs.

A Software Service Button (SSB) can perform in-app function(s) or function(s) through a platform operating system API as opposed to providing the inputs solely via the standard input device framework provided from the device operating system meant for standard game controller inputs (e.g., ABXY, L1/R1, L2/R2, D-Pad, Joysticks, Start, Select). (Start and Select are also sometimes known as Menu and Options.) In some embodiments, a software service button is a physical button of an electrical circuit that can be depressed by a user. In other embodiments, a software service button is a capacitive touch or other kind of soft button. Other input types may be used for SSB.

Hardware-initiative input events generally refers to when there is a change of the physical state of an input device. These events report up to software as having changed such as a button being pressed down.

Overlay actions refers to actions that have different sequences of hardware-initiative input events that are layered on default actions on software service buttons.

In certain embodiments, a mobile game controller can have one or more software service buttons each with a different set of overlays. By performing different input methods on the software service button, the platform operating service application records the methods then performs the action tied to the overlay action.

In one embodiment, an input event might include holding down a service button for 5 seconds (or some other programmed time). Another embodiment might include double pressing a service button with, for example, 3 seconds (again, or some other programmed time) in between button presses. In other embodiments, a triple press would be triple pressing a button with, for example, 3 secs (or some other programmed time) in between button presses.

In another embodiment, the overlay action on the software service button can inherit a platform's associated button behavior inside the application. For example: A user opens up the Playstation App, the software service button can now function as a Playstation button whenever triggered by the user.

In certain embodiments, a user can choose to add an overlay action on top of a software service button or keep the default behavior for the button. For example, a user presses a software service button twice in order to open up a different application/platform service such as Playstation App. The user will be able to either set up the overlay action to the input gesture or not.

In certain embodiments, a software service button overlay action could have dependencies such as other applications, platforms or have services tied to accounts linked to a user's account. When an overlay action requires a dependency such as an application like the Playstation app, the user can be prompted to resolve the missing dependency before setting the overlay action. For example, if an overlay action requires an application to be installed, the user may be prompted to download the missing application before the overlay action will work properly. In other embodiments, other accounts linked to the user's account such as a different content platform could signal for a user to install an application while setting up a software service button overlay action.

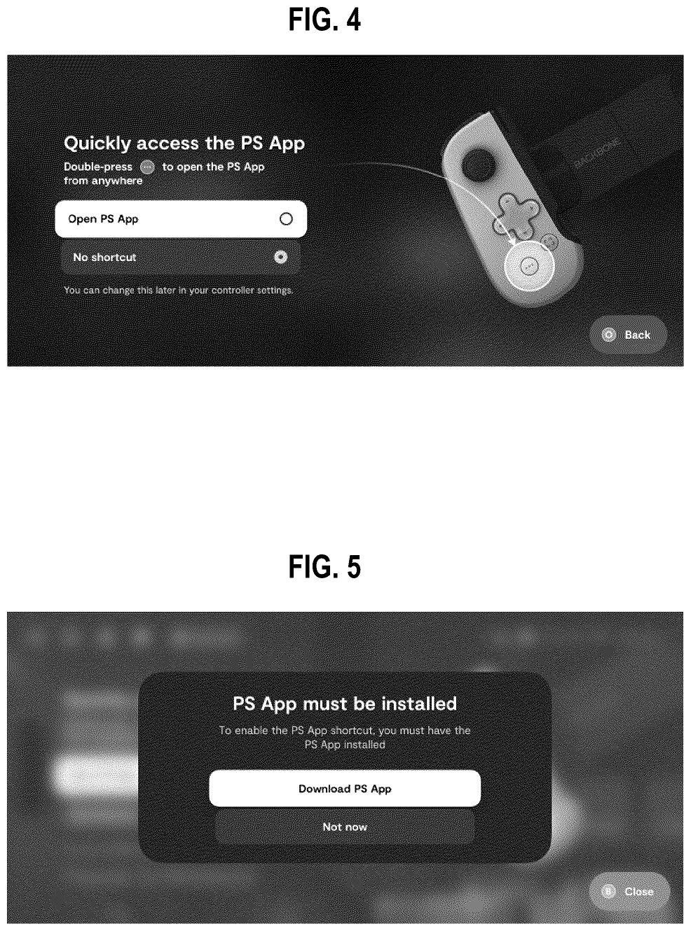

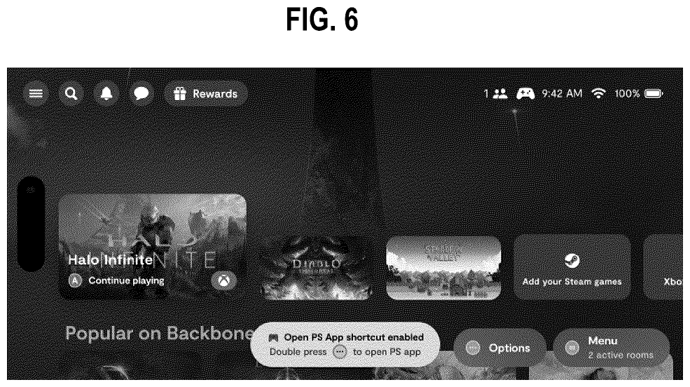

In FIG. 4, the user has double tapped a software service button (a button is shown in the figure with 3 dots, but any graphic or design may be used) and is presented with a screen to overlay an action on top of the button. If a dependency of the overlay action needs to be resolved, such as shown in FIG. 5 where, for example, the PS app needs to be installed, then the user is presented with an option to fix it. Once the dependency is resolved, they are given a message, per FIG. 6, to let them know the overlay action has been added successfully.

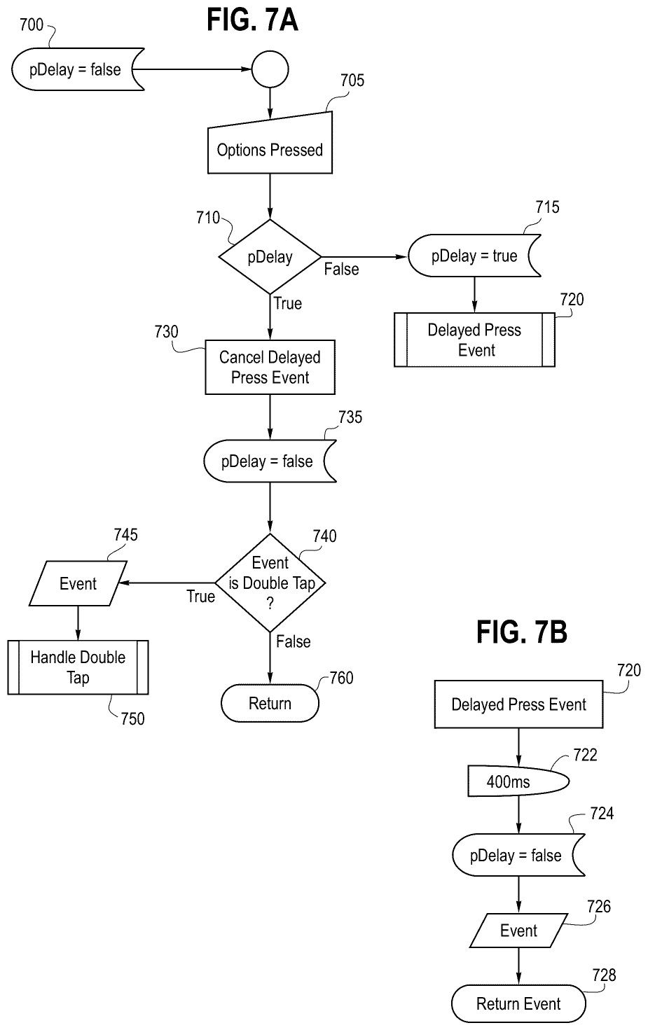

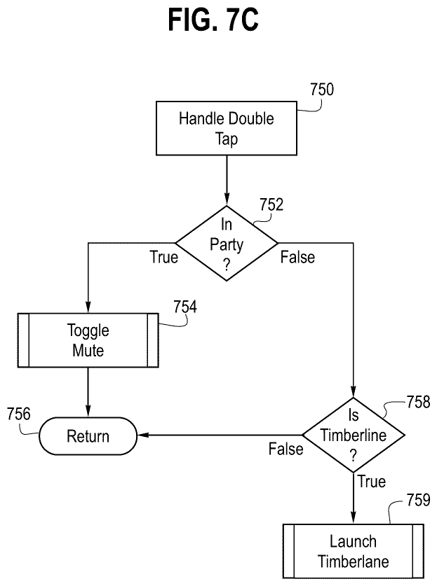

FIGS. 7A, 7B, and 7C are example flow diagrams of the input action on a software service button of an embodiment. As shown in these diagrams, an input delay is started on the first press for buttons that support a double tap feature that will interrupt the single press if a second press is triggered within the delay window (shown here as 400 ms, although a different time may be used if desired). If a second press is not received in that window, the event is passed along. If a second press is received, the initial single press is discarded, and the double press event is passed along. While double tap is illustrated here, other types of inputs (e.g., triple tap, long button hold, and so on) may be programmed.

More specifically, as shown in FIG. 7A, pDelay is set to false (act 700), and an options button is pressed (act 705). If pDelay is false, pDelay is set to true (act 715), and a delayed press event occurs (act 720). As shown in FIG. 7B, with the delayed press event, a 400 ms delay occurs (act 722), and pDelay is set to false (act 724). Then, an event occurs (act 726), and the event is returned (act 728). Returning to FIG. 7A, if pDelay is true, the delayed press event is cancelled (act 730), and pDelay is set as false (act 735). It is then determined whether the event is a double tap (act 740). If the event is not a double tap, the flow ends with a return (act 760). If the event is a double tap, the event occurs (act 745), and the double tap is handled (act 750). As shown in FIG. 7C, this can involve determining whether the system is in a party mode (act 752) (e.g., a user who could be in a communication group, such as voice, chat, or a mix of both). If it is, toggle is muted (act 754), and the flow returns (act 756). If it is not, it is determined whether a variant controller type or a platform specific game controller is being used (e.g., Timberline mode) (act 758), and, if it is, that mode is launched (act 759).

In other embodiments, a user would be able to set multiple overlay actions per the software service button based on different physical inputs (e.g. long presses, different number of presses) to take place through a user interface through the platform operating service application. The user would then be able to customize the software service buttons to perform various actions on the computing device.

In other embodiments, a user designates a set of sequenced hardware-initiated input events for an overlay action which they can select through a GUI interface within the platform operating service application. For example, they press a software service button four times with 3 seconds intervals to open the Twitch application.

### Software Service Button Action Configurations

To increase flexibility of the system, certain embodiments may utilize the platform operating system to transfer the software service button configurations saved to a user profile to different computing devices running the platform operating service application. A configuration could contain (but not limited to) the sequence of hardware-initiated input events and the actions mapped to those events.

For example:

| Events | Action |
|---|---|
| Double Press - SSB 1 | Open Playstation App |
| Hold 5000 ms - SSB 1 | Capture Current Screen |
| Triple Press - SSB 2 | Open Twitch Stream |

In one embodiment, the platform operating system downloads the configurations from the user profile from the platform operating service upon a computer device being hooked up to a mobile game controller. The configurations would be presented to the user through the platform operating service application. These configurations would be shown to the user to see what they have set for each software service button. The user would then be able to download the configurations to their application. The platform operating service application would then use configuration and inform the user of any additional actions needed to be taken for the overlay actions to be used such as downloading missing applications.

The user could also upload the configurations to their user profile through the platform operating system application to be used on other mobile game controllers. The user would be able to select which overlay actions to upload.

In other embodiments, the configurations could be saved to other file formats or other profile systems in order to transfer them through the platform operating service.

In other embodiments, the platform operating service could save the button configurations in the mobile game controller's flash storage. When the mobile game controller is connected to the platform operating service, one or more configurations can be read out for viewing or editing. Upon making changes, the platform operating service can save the new configuration to the controller. Storing the configuration inside the controller allows for the configuration to be portable to multiple computing devices where the platform operating service exists.

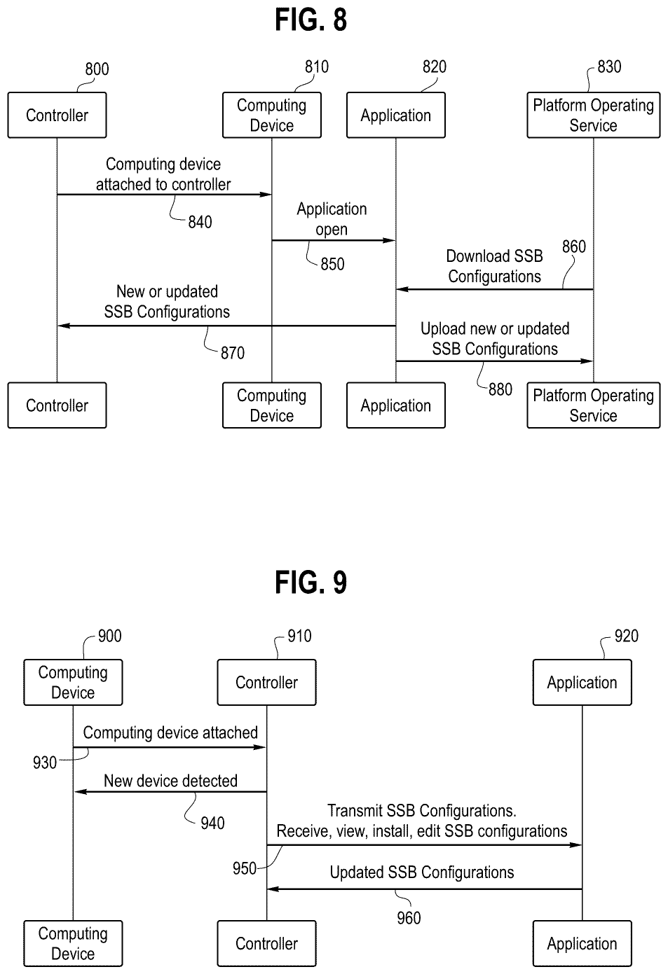

FIGS. 8 and 9 and block diagrams that illustrate the above. As shown in FIG. 8, the system in this embodiment comprises a controller 800, a computing device 810, an application 820, and a platform operating service 830. In operation, the computing device 810 is attached to the controller 810 (act 840), and the application 820 is opened (act 850). Next, the SSB configuration is downloaded from the platform operating service 830 (act 860), and the new or updated SSB configuration is provided to the controller 800 (act 870). Finally, the new or updated SSB configuration is provided to the platform operating service 830 (act 880). In FIG. 9, the system comprises a controller 900, a computing device 910, and an application 920. In operation, the computing device 910 is attached to the controller 910 (act 930), and a new device is detected (act 940). SSB configurations are then provided to the application 920 (act 950), and updated SSB configurations are provided for the controller 910 (act 960).

### CONCLUSION

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A method comprising:
performing by a platform operating service application in a computing device in communication with a mobile game controller:
receiving, from the mobile game controller, one or more user input events of a user input element of the mobile game controller, wherein the user input element is associated with a plurality of actions;
determining which action of the plurality of actions is associated with the received one or more user input events, wherein the determined action comprises causing a game application to open on the computing device; and
causing the game application to open on the computing device.

2. The method of claim 1, wherein the determined action depends on the mobile game controller being a platform-specific mobile game controller.

3. The method of claim 1, wherein at least one of the plurality of actions depends on whether a user is in a communications group.

4. The method of claim 1, wherein the plurality of actions comprises: opening the platform operating service application, switching to a previous application if the platform operating service application is in a foreground, opening an options menu, performing a screen capture, opening a streaming application, and/or muting a communications group.

5. The method of claim 1, wherein the user input element of the mobile game controller comprises a button.

6. The method of claim 5, wherein the one or more user input events comprises a single press of the button.

7. The method of claim 5, wherein the one or more user input events comprises holding down the button for a period of time.

8. The method of claim 5, wherein the one or more user input events comprises a plurality of presses of the button over a period of time.

9. The method of claim 1, wherein the platform operating service application is configured to receive the one or more user input events even when the platform operating service application is in a background.

10. The method of claim 1, wherein an association between user input events of the user input element and the plurality of actions is stored in a user profile.

11. The method of claim 1, further comprising:
downloading an association between user input events of the user input element and the plurality of actions.

12. A non-transitory computer-readable medium storing program instructions that, when executed by one or more processors of a computing device, cause the one or more processors to perform functions comprising:
providing a graphical user interface through which a user assigns an overlay action to a user input element of a mobile game controller, wherein the user input element has a default action, and wherein the overlay action is associated with one or more hardware-initiated input events of the user input element and comprises causing a game application on the computing device to open;
storing an association between the overlay action and the one or more hardware-initiated input events of the user input element.

13. The non-transitory computer-readable medium of claim 12, wherein the overlay action depends on the mobile game controller being a platform-specific mobile game controller.

14. The non-transitory computer-readable medium of claim 12, wherein the default action comprises: opening a platform operating service application, switching to a previous application if a platform operating service application is in a foreground, opening an options menu, performing a screen capture, opening a streaming application, and/or muting a communications group.

15. The non-transitory computer-readable medium of claim 12, wherein the program instructions, when executed by the one or more processors, further cause the one or more processors to perform functions comprising:
prompting the user to download the game application in response to the game application not being installed on the computing device.

16. The non-transitory computer-readable medium of claim 12, wherein the association is stored in a networked device for use with at least one other computing device.

17. The non-transitory computer-readable medium of claim 12, wherein the association is stored in a memory of the mobile game controller.

18. The non-transitory computer-readable medium of claim 12, wherein the association is stored in a user profile.

19. A mobile game controller comprising:
a user input element;
one or more processors;
a non-transitory computer-readable medium; and
program instructions stored on the non-transitory computer-readable medium that, when executed by the one or more processors, cause the one or more processors to perform functions comprising:
storing a mapping between a plurality of gestures of the user input element and a plurality of actions, wherein one of the plurality of actions comprises causing a game application to open on a computing device; and
providing the mapping to the computing device after the mobile game controller is connected with the computing device.

20. The mobile game controller of claim 19, wherein the program instructions, when executed by the one or more processors, further cause the one or more processors to perform functions comprising:
informing the computing device that the mobile game controller comprises a platform-specific mobile game controller, wherein at least one of the plurality of actions depends on the mobile game controller being a platform-specific mobile game controller.
